(19) United States
(12) Patent Application Publication
(10) Pub. No.: US 2025/0271591 A1
(43) Pub. Date: Aug. 28, 2025

(54) ARTIFICIAL INTELLIGENCE GEOPHYSICAL REMOTE SENSING INSTRUMENT

(71) Applicant: University Corporation for Atmospheric Research, Boulder, CO (US)

(72) Inventor: Jothiram Vivekanandan, Boulder, CO (US)

(21) Appl. No.: 19/064,537

(22) Filed: Feb. 26, 2025

Related U.S. Application Data
(60) Provisional application No. 63/557,903, filed on Feb. 26, 2024.

(51) Int. Cl. G01V 20/00; G01V 1/22; G06N 3/0442

(52) U.S. Cl. CPC G01V 20/00; G01V 1/223; G06N 3/0442; G01V 2210/614

(57) ABSTRACT

A method may receive measured data including a first time series of I component of signal data and a Q component of signal data. A method may execute a machine model using the measured data as input to generate model-generated data including a second time series of the I component of signal data and the Q component of signal data. A method may combine the measured data and the model-generated data into an augmented data. A method may generate a hybrid data product based on the augmented data.

### CROSS-REFERENCE TO RELATED APPLICATION

This application claims priority to U.S. Provisional Patent Application No. 63/557,903, filed on Feb. 26, 2024, the disclosure of which is incorporated by reference herein in its entirety.

### STATEMENT REGARDING FEDERALLY SPONSORED RESEARCH OR DEVELOPMENT

The subject matter disclosed in this application was made with Government support under award AGS-1755088, awarded by the National Science Foundation. The Government has certain rights in the disclosed subject matter.

### BACKGROUND

Geophysical instruments provide critical measurements needed for atmosphere, land and ocean characterization and navigation systems. For example, weather radars emit high-power radio waves that backscatter off atmospheric particles like raindrops, ice crystals, and snowflakes. By measuring the reflected signal, radar engineers retrieve key atmospheric characteristics, including reflectivity, radial velocity, and spectrum width. Radiometers determine atmospheric temperature, humidity, and water vapor content by detecting naturally emitted passive microwave radiation. Radars and radiometers rely on the I component of signal data, and the Q component of signal data to generate hybrid data products that estimate geophysical values and measurements. The accuracy of radar, radiometer, and other geophysical instrument measurements depend on the signal-to-noise ratio (SNR). Longer dwell times increase SNR while reducing scan rates, which can result in image blurring on moving platforms. Therefore, remote sensing system operators must balance dwell time, scan rate, and resolution to optimize data quality.

### SUMMARY

In some aspects, the techniques described herein relate to a method including: receiving measured data representing a first time series, the measured data including an I component of the measured data and a Q component of the measured data; executing a machine model using the measured data as input to generate model-generated data representing a second time series, the model-generated data including the I component and the Q component; combining the measured data and the model-generated data into an augmented data; and generating a hybrid data product based on the augmented data.

In some aspects, the techniques described herein relate to a system including: a processor; and a memory configured with code operable to: receive measured data representing a first time series, the measured data including an I component of the measured data and a Q component of the measured data; execute a machine model using the measured data as input to generate model-generated data representing a second time series, the model-generated data including the I component and the Q component; combine the measured data and the model-generated data into an augmented data; and generate a hybrid data product based on the augmented data.

In some aspects, the techniques described herein relate to a non-transitory computer-readable medium storing instructions that, when executed by a processor, cause a processor to: receive measured data representing a first time series, the measured data including an I component of the measured data and a Q component of the measured data; execute a machine model using the measured data as input to generate model-generated data representing a second time series, the model-generated data including the I component and the Q component; combine the measured data and the model-generated data into an augmented data; and generate a hybrid data product based on the augmented data.

### BRIEF DESCRIPTION OF THE DRAWINGS

FIG. 1 depicts a flow diagram of method, according to examples.

FIG. 2 depicts two plots of augmented data for a radar application, according to examples.

FIG. 3 depicts six scatterplots of data products for a radar application, according to examples.

FIG. 4 depicts two plots of augmented data for a radiometer application, according to examples.

FIG. 5A depicts two maps including measured data for radar reflectivity, according to examples.

FIG. 5B depicts a map and a histogram of the error between measured data and augmented data for a radar reflectivity application, according to examples.

FIG. 6 depicts a computing device that may be used to execute the methods described herein, according to examples.

### DETAILED DESCRIPTION

The present disclosure describes a method to augment measured geophysical data with model-generated data generated using artificial intelligence. The augmented data may be used to generate hybrid data products that estimate geophysical values and measurements, representing a combination of the measured and model-generated data. Because augmented data using a smaller number of measured data samples can replicate a full measured geophysical data set including a larger number of samples very closely, augmented data may offer the opportunity for instrument operators to obtain higher spatial and/or temporal resolution geophysical hybrid data than previously possible using existing instrumentation.

It is a technical problem that in remote sensing applications, adequate signal-to-noise ratio (SNR) is needed to generate accurate measurements. To improve SNR, scientists and engineers typically configure observations with longer dwell times, which can reduce the spatial or temporal resolution of the data. Alternatively new instruments must be designed to improve SNR and obtain better data accuracy.

The present disclosure presents the technical solution of creating model-generated data using artificial intelligence using a smaller set of measured data as input. The measured data is then combined with the model-generated data to generate an augmented data that can achieve the target SNR. The augmented data can then be used to determine an intermediate or a hybrid data product.

The technical advantages of the solutions described herein include the ability to generate an accurate hybrid data product based on measured data that has fewer samples and/or lower dwell times, replicating measured data that would otherwise require more samples and/or longer dwell times to obtain. The methods described enhance a seed-measured data set that includes fewer samples to provide hybrid data products with increased accuracy over the original seed measured data set, expanding the scope of what can be measured and learned with existing instrumentation.

While implementations of radiometer and radar instruments are discussed herein, they are not intended to be limiting. In examples, the techniques described herein may be used with any geophysical instrument that generates voltage amplitude and phase data.

A remote sensing system, for example a radar weather system and radiometer, may consist of several key components working together for signal transmission and reception. In one example, a GPS may provide a stable reference for the Stable Local Oscillator (STALO), which may generate the transmitter carrier frequency fs, receiver local oscillator frequencies, and the Coherent Oscillator (COHO) frequency fc for signal processing. The COHO may ensure coherency between successive transmitted pulses by offsetting the STALO frequency to match the receiver Intermediate Frequency (IF).

In examples, the radar transmitter may generate high-power RF pulses using a magnetron, klystron, or solid-state power amplifier. An antenna, for example a parabolic dish or phased array, may amplify transmitted pulses and receive backscattered signals in a monostatic configuration.

In examples, the receiver may include an amplifier to boost weak return signals. These signals may be mixed with carrier frequency fs to down-convert to IF, then processed using a matched filter. Finally, the IF signals may be further down-converted to baseband and split into in-phase (I) and quadrature (Q) components using sine and cosine local oscillators at frequency fc.

The I component of the signal data and the Q component of the signal data are important in weather radar applications because they preserve both the amplitude and phase of received radar signals, which enables advanced signal processing. Some modern digital receivers directly sample the RF signal to obtain digital representations of the I component and the Q component of time series data. The I component and the Q component of signal data are digitized by analog-to-digital converters (ADC) in the receiver for further subsequent processing.

In examples, a weather radar may collect between 16, 128 or larger numbers of samples of received signals for estimating a data product or a radar observation. Because the individual power of a radar signal's standard deviation is the same as the mean value of the power, a large number of samples are necessary for estimating radar observations. Disclosed implementations may use a combination of the lower number of received signals and AI model-generated data from the received signals for estimating the radar observations. A recurrent neural network forecasts radar signals using fewer received signals, e.g., 16 instead of traditional 32, 64 or larger number of samples.

In examples, a radiometer antenna system may receive horizontal (H) and vertical (V) polarized signals from the geophysical scene. An orthomode transducer may ensure these polarizations remain orthogonal, preventing interference. In examples, a superheterodyne receiver with low-noise amplifiers may convert the high-frequency RF signals to a lower IF for easier processing.

Radiometers detect passive radiation from individual hydrometeors and geophysical features within a resolution volume. These features, such as water droplets, ice crystals, soil moisture, and other particles, vary in size, shape, dielectric properties and geophysical features, leading to a wide range of scattering and emission behaviors of atmosphere, land and ocean. The combined effect of multiple sources results in a signal that is random in nature, both in amplitude and phase.

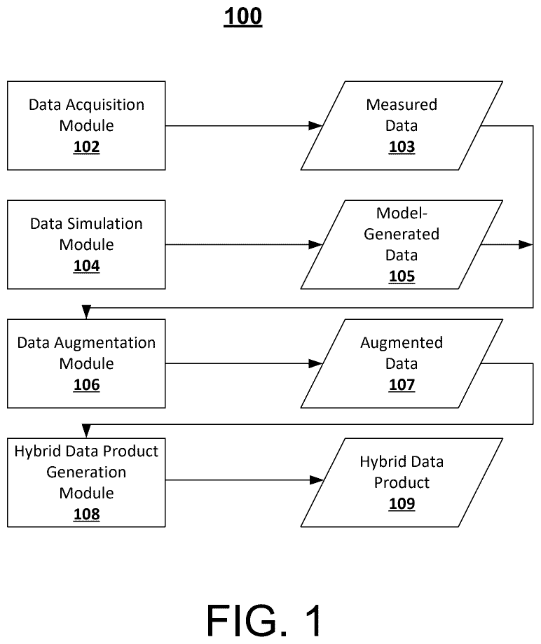

FIG. 1 depicts a flow diagram 100, in accordance with an embodiment. FIG. 1 is discussed below with respect to a system using radar and radiometer data for generating a hybrid data product representing coherent radar products and radiometric retrieval. However, this is for ease of discussion and implementations are not limited to using radar and radiometer data to predict geophysical data products. The method depicted in flow diagram 100 may be used to generate a hybrid data product (i.e., predicted, forecasted, inferred, or simulated data) representing a geophysical value or an intermediate data product from the I and Q components of signal data. In examples, the method may include any combination of modules 102-108.

The flow diagram 100 begins with data acquisition module 102. In data acquisition module 102, measured data 103 is received. In examples, measured data 103 may include a time series of raw phase and amplitude voltage data obtained from physical sensors. In examples, the measured data 103 may include the I and Q components of signal data.

For example, measured data 103 may be received from a radar or a radiometer instrument. A received radar signal s(t), representing a raw voltage signal that captures both amplitude and phase, may be obtained as a time series of analog to digital converter voltage measurements. The received radar signal s(t) may represent measured data, including a time series of I and Q components of signal data, where the I component (In-phase) represents the real part of the signal and the Q component (Quadrature) represents the imaginary part. These components collectively encode both amplitude and phase information. The mathematical description of the I component of signal data and the Q component of signal data in both radar and radiometer systems are similar, especially when considering the random nature of typical sources. The received radar signal s(t) may be represented as:

$$s ( t ) = A ( t ) cos [ 2 π {f}_{c} t + φ ( t ) ] \qquad ( Equation 1 )$$

Where A(t) is the time-varying amplitude, f_{c} is the coherent oscillator frequency, φ(t) is the time-varying phase, and t is time. The s(t) signal may next be mixed with two mixer outputs in the receiver:

$$mI ( t ) = cos ( 2 π {f}_{c} t ) , and \qquad ( Equation 2 )$$

$$mQ ( t ) = sin ( 2 π {f}_{c} t ) , \qquad ( Equation 3 )$$

wherein mI(t) represents the in-phase mixer and mQ(t) represents the quadrature mixer. Multiplying s(t) with each of mI(t) and mQ(t) and low-pass filtering provides the following baseband signals:

$$I ( t ) = A ( t ) cos [ 2 π {f}_{c} t + φ ( t ) ] * cos ( 2 π {f}_{c} t ) = 0.5 A ( t ) cos φ ( t ) , and \qquad ( Equation 4 )$$

$$Q ( t ) = A ( t ) cos [ 2 π {f}_{c} t + φ ( t ) ] * sin ( 2 π {f}_{c} t ) = 0.5 A ( t ) sin φ ( t ) . \qquad ( Equation 5 )$$

The amplitude and phase of the received signals are therefore:

$$A ( t ) = 2 \sqrt{( {I}^{2} + {Q}^{2} )} , and \qquad ( Equation 6 )$$

$$φ ( t ) = {tan}^{- 1} ( Q / I ) . \qquad ( Equation 7 )$$

So, the received signal may be represented in terms of I and Q as:

$$V ( t ) = I ( t ) + iQ ( t ) \qquad ( Equation 8 )$$

wherein V(t) represents voltage, I(t) and iQ(t) represent time series I component of signal data and Q component of signal data, respectively.

Once the I component of signal data and Q component of signal data is received, the method may continue with data simulation module 104. In data simulation module 104, model-generated data 105 may be generated based on measured data 103 based on a machine learning model.

The time series I component of signal data and Q component of signal data is a superposition of at least distinct physical components, including trends indicative of long-term behavior, oscillations reflective of periodic changes, and noise encapsulating the residual variability. Decomposing this data in post-processing may facilitate a more granular understanding of the radar data, making it possible to distinguish between different weather patterns based on underlying trends and variations.

The universe of geophysical I component of signal data and Q component of signal data is, somewhat surprisingly, not infinitely complex. There is a finite set of combinations of mean velocity and Doppler spectrum width that can be observed in the natural meteorological environment using radar or radiometer. Furthermore, there are only a limited number of atmospheric conditions, ground features, and ocean features that can be observed. The finite nature of the conditions found in the physical environment indicates that there may be a limited number of unique time series associated with geophysical signals. This concept is fundamental to the fields of radar meteorology and microwave radiometry. Understanding this limitation lays the groundwork for the potential to simulate data to augment measured data that includes time series data.

In examples the machine learning model may comprise a neural network and/or deep learning. Neural networks are a powerful class of machine learning algorithms modeled after the human brain. Neural networks may consist of layers of neurons that learn by adjusting weights and biases through forward propagation and backpropagation. They are often applied to tasks involving the learning of complex patterns and relationships in data, making them a crucial component of modern artificial intelligence systems. They are used in various types of machine learning, including supervised, unsupervised, and reinforcement learning.

Deep learning is a subset of machine learning that enables computers to perform tasks that come naturally to humans: learning from experience. It utilizes neural networks to identify valuable features directly from data. These neural networks consist of multiple nonlinear processing layers that operate in parallel, drawing inspiration from biological nervous systems. Deep learning models can achieve state-of-the-art accuracy in object classification, often surpassing human-level performance.

In examples, the machine learning model may comprise a recurrent neural network (RNN). RNNs are a class of neural networks architected to process sequential data, making them an excellent fit for handling time series information, such as radar and radiometer signals. The temporal dependency of radar and radiometer signals is well-captured by RNNs' inherent architecture, allowing them to extrapolate future signal patterns based on past data.

In examples, the machine learning model may comprise an LSTM (Long Short-Term Memory) network is a type of RNN that processes input data sequentially by iterating over time-steps and updating the RNN state. An LSTM layer learns long-term dependencies within time-series and sequence data. The RNN state retains information from all previous time steps. By using prior time steps as input, an LSTM neural network can forecast subsequent values in a time series or sequence. To train an LSTM neural network for time series forecasting, a regression LSTM with sequence output may be used, where the target responses are the training sequences with values shifted by one time step. In simpler terms, at each time step of the input sequence, the LSTM network learns to predict the value of the next time step.

The success of the machine learning model may be dependent upon the training of the model. In examples, the machine learning model may be trained using supervised learning, unsupervised learning, or reinforcement learning.

Supervised learning makes use of data with input-output pairs. The model's output is compared to a desired output, and any discrepancy, referred to as an error signal, is then fed back into the network to adjust the weights of the connections until the model's output aligns with the desired output or no further changes can be affected.

In unsupervised learning, no feedback is generated based on a desired output, instead the model learns independently. During the training phase, inputs are organized into classes that contain similar input patterns. When a new pattern is presented, the model may predict which class it belongs to based on its similarity to each class's patterns. If a new pattern is not similar enough to an existing class, a new class is created.

A further approach is reinforcement learning, which combines some strengths of both supervised and unsupervised learning. Reinforcement learning creates a learning process that operates based on feedback from a critique. The model learns independently based on critique information. While it shares similarities with supervised learning by receiving feedback, it differs in that it does not get direct output information; instead, it works with evaluative feedback.

In examples, the machine learning model may be trained on historical data. In examples, the machine learning model may be trained on radar or radiometer data. Incorporating RNNs into radar and radiometer systems may require substantial training data to increase the accuracy of the output, however. Therefore, large and diverse datasets can be helpful. In examples, the measured data may include time series data capturing a wide range of observation conditions such as, for example, different pulse lengths, weather conditions, scan configurations, etc. In examples, the length of the measured data used to train the model may include a variety of dwell times and/or radar pulse lengths. In examples, the machine learning model may be trained using historical data measured with a geophysical instrument. In such cases, the measured data used to generate a hybrid data product is measured with the same instance of a geophysical instrument. In further examples, however, the measured data used to generate a hybrid data product may be measured with a different instance of the geophysical instrument, or in other words a geophysical instrument of the same type or class of instrument even if not the same instrument.

In examples, open-loop forecasting or closed-loop forecasting may be used to generate model-generated data 105.

Open-loop forecasting is also referred to as one step ahead forecasting. When making predictions for a time step n, open-loop forecasting relies on the measured data 103 pre-dating the time step n as input to the machine learning model, removing the model-generated data 105 pre-dating the time step as an input. For example, the measured data 103 collected between time steps 1 through t−1 may be used to determine the model-generated data 105 for time step t. Augmented data 107 is an enhanced data set that uses measured data 103 as a seed to that is used to generate the model-generated data 105.

Unlike open-loop forecasting, closed-loop forecasting does not require exclusively measured data 103 to make predictions. Closed-loop forecasting may use both measured data 103 and model-generated data 105 as inputs to generate data as it steps through a time series. For instance, the data from time steps 1 through t−1, which may include measured data 103 and/or model-generated data 105, may be used to predict the values for time steps t through t+k.

In examples, the flow diagram 100 may continue with a data augmentation module 106. In data augmentation module 106, augmented data 107 is generated based on measured data 103 and model-generated data 105. For example, the measured data 103 may be received for time series indexes t=1 to n, and model-generated data 105 may be generated for time series indexes t=n+1 to k. The measured data 103 may be concatenated with the model-generated data 105 to generate the augmented data 107.

In examples, the measured data 103 may include a first number of time steps and the model-generated data 105 may include a second number of samples that is at least three times the first number of time steps. For example, the measured data 103 may include the first 16 time steps and the model-generated data 105 may include the second 48 time steps in the augmented data 107, where the augmented data 107 is a 64 time step series. In examples, the augmented data 107 may include a proportion of measured data 103 that is 15% or greater, 20% or greater, 25% or greater, or 30% or greater than the proportion of augmented data 107.

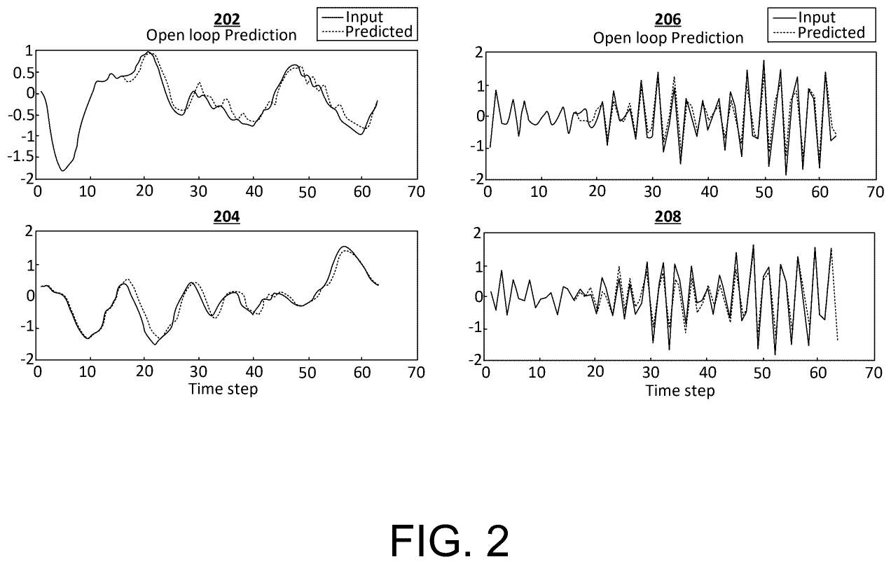

For example, FIG. 2 depicts two examples of augmented data for a radar application, according to examples. Graph 202 depicts I component of signal data and graph 204 depicts Q component of signal data for a slow-varying data example, and graph 206 depicts I component of signal data and graph 208 depicts Q component of signal data for a fast-varying data example. The x-axis of the graphs is time and the y-axis of the graph is un-normalized signal voltage. Each of graphs 202-208 was generated with measured data 103 that is 16 time steps in length and model-generated data 105 that is 48 time steps in length. In the example of FIG. 2, the example measured data 103 is generated using a Doppler spectrum approach via MATLAB.

In examples, the example augmented data 107 in FIG. 2 is generated using LSTM combined with open-loop predictions. The dotted line that spans from time step 17 to 64 is model-generated data 105 generated based on steps 1-16 of the measured data 103. By overlaying the measured data 103 with the model-generated data 105 from steps 17-64, it is possible to see how closely the model-generated data 105 tracks the features of the measured data 103. While there are small differences between the amplitudes of the peaks and troughs of the data, the features of the measured data 103 are clearly tracked by the model-generated data 105 in the figures.

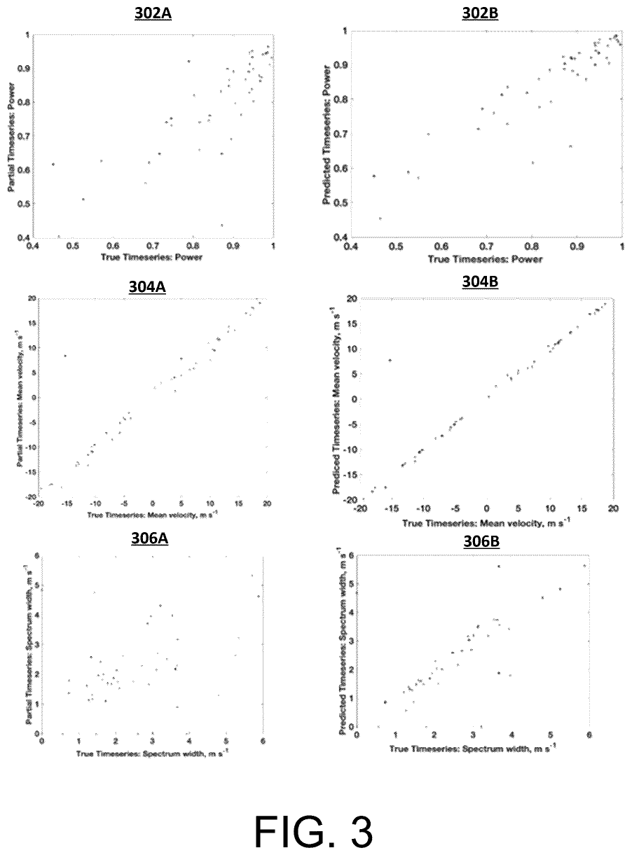

FIG. 3 depicts a series of scatterplots for a radar application: a graph 302A, a graph 302B, a graph 304A, a graph 304B, a graph 306A, and a graph 306B. In each of the graphs, the x-axis represents a data product estimated based on a 64 time step measured data 103 without any model-generated data. In graphs 302A, 304A, and 306A, the y-axis represents a data product estimated based on a 16 time step (low dwell time/under sampled) measured data 103 that is not enhanced with model-generated data. In graphs 302B, 304B, and 306B, however, the y-axis represents a hybrid data product 109 based on the 16 time step measured data 103 and 48 time step model-generated data 105. In other words, the “A” series graphs depict scatter plots of data products based on low dwell time measured data alone and the “B” series graphs depict scatter plots of hybrid data products based on the low dwell time measured data augmented with model-generated data. In graphs 302A and 302B, the data product depicted is signal power, for graphs 304A and 304B the data product depicted is Doppler velocity, and for graphs 306A and 306B the data product depicted is Doppler spectrum width.

It may be seen in FIG. 3 that the “B” series graphs 302B, 304B, and 306B, the dots are closer to the diagonal line than each of “A” series graphs 302A, 304A, and 306A, respectively, indicating lower error and greater data product accuracy. Put another way, the inclusion of model-generated data improves the quality (measured by lower error and greater product accuracy) of the data products generated using under sampled measured data 103. As captured in Table I below, the root mean square of the hybrid data product 109 estimated based on the augmented data 107 for each type of data is lower than the root mean square of the data products estimated based on the 16 time step measured data. In the example of the signal power, based on the same 16 time step (low dwell time) measured data, the methods of the present disclosure reduce the error of the estimated data product by from 0.06 to 0.02 root mean square.

TABLE I

| | Root mean square | Root mean square values |
|---|---|---|
| | values of data | of hybrid data product |
| | product estimated | estimated based on 16 |
| | based on 16 time | time steps of measured |
| | steps of measured | data and 48 time steps |
| Parameters | data | of model-generated data |
| Signal power | 0.06 | 0.02 |
| Doppler velocity | 0.47 m/s | 0.44 m/s |
| Doppler spectrum width | 0.72 m/s | 1.26 m/s |

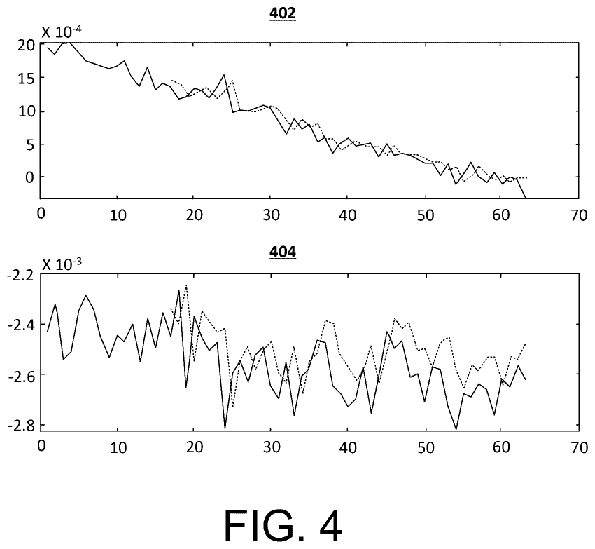

FIG. 4 depicts an example of augmented data for a radiometer application, according to examples. Graph 402 depicts the I component and graph 404 depicts the Q component for solar radiation data that is not normalized, collected by an S-band (3 GHz) radar receiver. The complete 64 time steps of measured data 103 is depicted with a solid line while the model-generated data 105 is depicted with a dotted line. The initial 16 time steps of the measured data 103 was used to generate the model-generated data 105, which ranges from time step 17 to 64. As may be seen again, the features found between time steps 17 and 64 of the measured data 103 and model-generated data 105 trend together. The error between the data is 3.682996.

As demonstrated in the discussion of FIGS. 2-4 above, the methods of the disclosure may be used to enhance a measured data set having few samples to generate augmented data having substantially the same accuracy of a much larger dataset.

In examples, the flow diagram 100 may continue with hybrid data product generation module 108. In hybrid data product generation module 108, a hybrid data product 109 may be determined based on the augmented data 107. The augmented data 107 includes a time series of measured data 103 and model-generated data 105 that includes the I component and the Q component. In the example of a radar, the I component and the Q component of signal data may be used to determine: a signal power, a Doppler velocity (a radial velocity), a Doppler spectrum width, and/or a reflectivity. In the example of a radiometer instrument, the I component and the Q component may be used to determine: a brightness temperature, an antenna temperature, a system noise temperature, stokes parameters, a polarization ratio, a microwave emissivity, an integrated water vapor, a cloud liquid water content, a precipitation rate, a temperature profile, or a humidity profile.

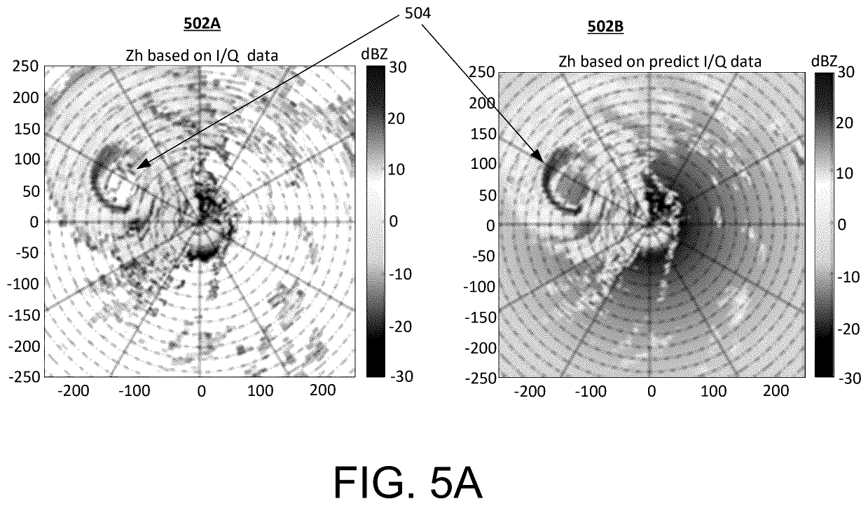

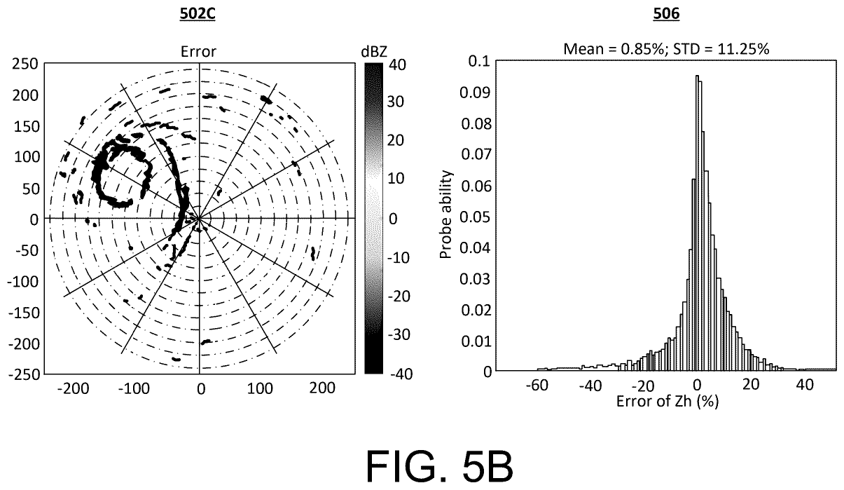

FIG. 5A depicts two maps including measured radar reflectivity data, according to examples. The data depicted in the maps is provided by a NOAA NexRad radar. Map 502A and map 502B each depict reflectivity over the same region at the same time, capturing a round cyclone feature 504 in the upper left quadrant. In map 502A, the reflectivity was determined based on 64 time step measured data 103, and in map 502B, the reflectivity was determined based on hybrid data product 109 determined from augmented data 107 including 16 time step measured data 103 and 48 time step model-generated data 105. As may be seen, the features of map 502A appear to also be present in the map 502B.

FIG. 5B depicts the error between the measured reflectivity data and the augmented reflectivity data, according to examples. FIG. 5B depicts the error or difference between the measured reflectivity data depicted in map 502A and the augmented reflectivity data depicted in map 502B. A histogram 506 includes the error across map 502C. From the histogram 506, it may be seen that the mean error of the augmented reflectivity data is 0.85% and the standard deviation is 11.25%. Thus, less than 1% error is achieved with machine-generated data using data that can be acquired in 25% of the time of a traditional measurement.

In examples, incorporating a machine learning model into a radar or radiometer operation may include optimizing the model to process data at speed for real-time performance. In examples, achieving real-time performance may require hardware optimization. In examples, the methods described herein may be used with specialized processing units like GPUs or FPGAs, to balance computational demands and real-time response.

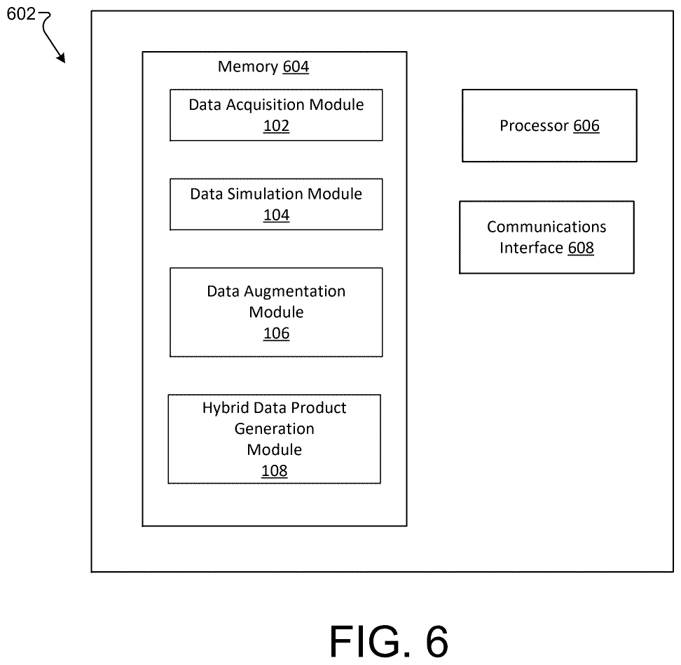

FIG. 6 depicts a computing device 602 that may be used to execute the methods described herein, according to examples. In examples, computing device 602 may be an embedded device co-located with a geophysical instrument, for example a radar or radiometer, or computing device 602 may be remotely located. In examples, computing device 602 may be used to process data from the geophysical instrument in real time or in post-processing.

Computing device 602 includes a memory 604, a processor 606, and a communications interface 608. In examples, memory 604 may include one or more memories. In examples, processor 606 may include one or more processors. Memory 604 may include one or more modules operable to execute the method depicted in the flow diagram 100. For example, memory 604 may include any combination of the data acquisition module 102, the data simulation module 104, the data augmentation module 106 and the hybrid data product generation module 108.

In examples, computing device 602 may receive raw data or measured data from a geophysical instrument. In examples, the computing device 602 may also communicate with a server over a network (not depicted). For example, the computing device 602 may send any combination of measured data 103, model-generated data 105, augmented data 107, or hybrid data product 109 to a server for storage or further processing.

The methods described herein, may significantly reduce a required sample size for a time series of I component of signal data and Q component of signal data without undermining the accuracy of the observation. Generating model-generated data from measured data and has the potential to enable geophysical systems to operate with substantially lower dwell times over prior measurements, while maintaining a comparable level of accuracy.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for the purposes of describing example implementations. Example implementations, however, have many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a method, wherein the measured data includes a first number of samples and the model-generated data includes a second number of samples that is at least three times the first number of samples.

In some aspects, the techniques described herein relate to a method, wherein the measured data includes radar data or radiometer data.

In some aspects, the techniques described herein relate to a method, wherein a geophysical instrument is used to obtain the measured data and the machine model is trained with historical data measured with the geophysical instrument of the same type.

In some aspects, the techniques described herein relate to a method, wherein the model-generated data is generated using open-loop forecasting.

In some aspects, the techniques described herein relate to a method, wherein the hybrid data product is at least one of a signal power, Doppler velocity, or velocity standard deviation or Doppler spectrum width.

In some aspects, the techniques described herein relate to a system, wherein the measured data includes a first number of samples and the model-generated data includes a second number of samples that is at least three times the first number of samples.

In some aspects, the techniques described herein relate to a system, wherein the measured data includes radar data or radiometer data.

In some aspects, the techniques described herein relate to a system, wherein a geophysical instrument is used to obtain the measured data and the machine model is trained with historical data measured with the geophysical instrument of the same type.

In some aspects, the techniques described herein relate to a system, wherein the model-generated data is generated using open-loop forecasting.

In some aspects, the techniques described herein relate to a system, wherein the hybrid data product is at least one of a signal power, Doppler velocity, and velocity standard deviation or Doppler spectrum width.

In some aspects, the techniques described herein relate to a method, wherein the machine model is a long short-term memory network.

In some aspects, the techniques described herein relate to a system, wherein the machine model is a long short-term memory network.

In some aspects, the techniques described herein relate to a non-transitory computer-readable medium, wherein the measured data includes a first number of samples and the model-generated data includes a second number of samples that is at least three times the first number of samples.

In some aspects, the techniques described herein relate to a non-transitory computer-readable medium, wherein the measured data includes radar data or radiometer data.

In some aspects, the techniques described herein relate to a non-transitory computer-readable medium, wherein the model-generated data is generated using open-loop forecasting.

In some aspects, the techniques described herein relate to a non-transitory computer-readable medium, wherein the hybrid data product is at least one of a signal power, Doppler velocity, and velocity standard deviation or Doppler spectrum width.

In some aspects, the techniques described herein relate to a non-transitory computer-readable medium, wherein the machine model is a long short-term memory network.

What is claimed is:

1. A method comprising:
receiving measured data representing a first time series, the measured data including an I component of the measured data and a Q component of the measured data;
executing a machine model using the measured data as input to generate model-generated data representing a second time series, the model-generated data including the I component and the Q component;
combining the measured data and the model-generated data into an augmented data; and
generating a hybrid data product based on the augmented data.

2. The method of claim 1, wherein the measured data includes a first number of samples and the model-generated data includes a second number of samples that is at least three times the first number of samples.

3. The method of claim 1, wherein the measured data comprises radar data or radiometer data.

4. The method of claim 1, wherein a geophysical instrument is used to obtain the measured data and the machine model is trained with historical data measured with the geophysical instrument of a same type.

5. The method of claim 1, wherein the model-generated data is generated using open-loop forecasting.

6. The method of claim 1, wherein the hybrid data product is at least one of a signal power, Doppler velocity, or velocity standard deviation or Doppler spectrum width.

7. The method of claim 1, wherein the machine model is a long short-term memory network.

8. The method of claim 1, wherein the second time series represents time steps after the first time series.

9. A system comprising:
a processor; and
a memory configured with code operable to:
receive measured data representing a first time series, the measured data including an I component of the measured data and a Q component of the measured data;
execute a machine model using the measured data as input to generate model-generated data representing a second time series, the model-generated data including the I component and the Q component;
combine the measured data and the model-generated data into an augmented data; and
generate a hybrid data product based on the augmented data.

10. The system of claim 9, wherein the measured data includes a first number of samples and the model-generated data includes a second number of samples that is at least three times the first number of samples.

11. The system of claim 9, wherein the measured data comprises radar data or radiometer data.

12. The system of claim 9, wherein a geophysical instrument is used to obtain the measured data and the machine model is trained with historical data measured with the geophysical instrument of a same type.

13. The system of claim 9, wherein the model-generated data is generated using open-loop forecasting.

14. The system of claim 9, wherein the hybrid data product is at least one of a signal power, Doppler velocity, and velocity standard deviation or Doppler spectrum width.

15. The system of claim 9, wherein the machine model is a long short-term memory network.

16. A non-transitory computer-readable medium storing instructions that, when executed by a processor, cause a processor to:
receive measured data representing a first time series, the measured data including an I component of the measured data and a Q component of the measured data;
execute a machine model using the measured data as input to generate model-generated data representing a second time series, the model-generated data including the I component and the Q component;
combine the measured data and the model-generated data into an augmented data; and
generate a hybrid data product based on the augmented data.

17. The non-transitory computer-readable medium of claim 16, wherein the measured data includes a first number of samples and the model-generated data includes a second number of samples that is at least three times the first number of samples.

18. The non-transitory computer-readable medium of claim 16, wherein the measured data comprises radar data or radiometer data.

19. The non-transitory computer-readable medium of claim 16, wherein the model-generated data is generated using open-loop forecasting.

20. The non-transitory computer-readable medium of claim 16, wherein the hybrid data product is at least one of a signal power, Doppler velocity, and velocity standard deviation or Doppler spectrum width.
